(19) United States
(12) Patent Application Publication
(10) Pub. No.: US 2025/0126430 A1
(43) Pub. Date: Apr. 17, 2025

(54) SIGNAL PROCESSING DEVICE, SIGNAL PROCESSING METHOD, AND PROGRAM

(71) Applicant: SONY GROUP CORPORATION, TOKYO (JP)

(72) Inventor: RYUTARO WATANABE, TOKYO (JP)

(21) Appl. No.: 18/293,397

(22) PCT Filed: Mar. 8, 2022
(86) PCT No.: PCT/JP2022/009956

§ 371 Date: Jan. 30, 2024

(30) Foreign Application Priority Data
Aug. 27, 2021 (JP) 2021-138577

(51) Int. Cl. H04S 7/00

(52) U.S. Cl. CPC H04S 7/304; H04S 2420/01

(57) ABSTRACT

The present technology relates to a signal processing device, a signal processing method, and a program capable of reproducing a sound emitted from a virtual sound source according to a shape of a user's head with high accuracy. A signal processing device according to the present technology includes a generation unit that generates a second HRTF from a second sound source position at the same angle as a first sound source position with reference to a position of a user to the position of the user by changing interaural information indicated by a first HRTF from the first sound source position to the position of the user according to a shape of the user's head. The present technology can be applied to, for example, the signal processing device that reproduces a sound source bit stream.

### TECHNICAL FIELD

The present technology relates to a signal processing device, a signal processing method, and a program, and more particularly, to a signal processing device, a signal processing method, and a program capable of reproducing a sound emitted from a virtual sound source according to a shape of a user's head with high accuracy.

### BACKGROUND ART

Performing calculation using a head related transfer function (HRTF) allows a sound image to be localized at a predetermined position, enabling a sound heard from headphones to be stereoscopically reproduced. For example, Patent Literature 1 describes that the head related transfer function for each individual is formed, and a sound pressure from a sound source at a certain position is actually reproduced using the head related transfer function for each individual.

It is known that the HRTF for a sound source at a distance of, for example, 1 m or more from a position of a user does not change depending on the distance from the position of the user to the sound source. Therefore, in a case of reproducing a sound output from the sound source at the distance of 1 m or more from the position of the user, an HRTF (far-field HRTF) for a sound source at a distance of 1 m from the position of the user is used.

In a case of reproducing a sound output from a sound source at a distance of, for example, less than 1 m from the position of the user, an HRTF (near-field HRTF) for the sound source is required.

### CITATION LIST

### Patent Document

Patent Document 1: Japanese Patent Application Laid-Open No. 2015-19360

### SUMMARY OF THE INVENTION

### Problems to be Solved by the Invention

Known is a method for generating a near-field HRTF from a far-field HRTF by changing an interaural time difference (ITD) and an interaural level difference (ILD) according to a distance from a position of a user to a sound source.

Since the ITD and the ILD vary depending on the size of the use's head, the differences of the ITD and the ILD between the far-field HRTF and the near-field HRTF also vary depending on the size of the user's head. Therefore, in order to generate the near-field HRTF from the far-field HRTF, it is desirable to appropriately change the ITD and the ILD according to the size of the user's head.

The present technology has been made in view of such a situation, and aims to enable reproduction of a sound emitted from a virtual sound source according to the shape of the user's head with high accuracy.

### Solutions to Problems

A signal processing device according to one aspect of the present technology includes a generation unit that generates a second HRTF from a second sound source position to a position of a user by changing interaural information indicated by a first HRTF from a first sound source position to the position of the user according to a shape of the user's head, the second sound source position being at the same angle as the first sound source position with reference to the position of the user.

A signal processing method according to one aspect of the present technology includes generating a second HRTF from a second sound source position to a position of a user by changing interaural information indicated by a first HRTF from the first sound source position to the position of the user according to a shape of the user's head, the second sound source position being at the same angle as the first sound source position with reference to the position of the user.

A program according to one aspect of the present technology causes a computer to execute processing of generating a second HRTF from a second sound source position to a position of a user by changing interaural information indicated by a first HRTF from a first sound source position to the position of the user according to a shape of the user's head, the second sound source position being at the same angle as the first sound source position with reference to the position of the user.

In one aspect of the present technology, a second HRTF from a second sound source position to a position of a user is generated by changing interaural information indicated by a first HRTF from a first sound source position to the position of the user according to a shape of the user's head, the second sound source position being at the same angle as the first sound source position with reference to the position of the user.

### BRIEF DESCRIPTION OF DRAWINGS

FIG. 1 is a block diagram illustrating a configuration example of an acoustic system according to an embodiment of the present technology.

FIG. 2 is a diagram illustrating an example of an HRTF.

FIG. 3 is a diagram illustrating an example of a method of estimating a near-field HRTF.

FIG. 4 is a diagram illustrating an example of an ILD according to a head size.

FIG. 5 is a block diagram illustrating a first configuration example of a signal processing device.

FIG. 6 is a diagram illustrating an example of information to be registered in a change characteristic database.

FIG. 7 is a diagram illustrating an example of amounts of change in an ITD and an ILD.

FIG. 8 is a flowchart illustrating processing performed by the signal processing device having the configuration of FIG. 5.

FIG. 9 is a block diagram illustrating a second configuration example of the signal processing device.

FIG. 10 is a block diagram illustrating a third configuration example of the signal processing device.

FIG. 11 is a block diagram illustrating a fourth configuration example of the signal processing device.

FIG. 12 is a flowchart illustrating processing performed by the signal processing device having the configuration of FIG. 11.

FIG. 13 is a block diagram illustrating a fifth configuration example of the signal processing device.

FIG. 14 is a diagram illustrating a flow of adjustment of difference amounts of the ITD and the ILD.

FIG. 15 is a diagram illustrating an example of a far-field sound source position to be determined on the basis of an azimuth angle and an elevation angle in a coordinate system with respect to a position of an entrance of an ear canal.

FIG. 16 is a block diagram illustrating a sixth configuration example of the signal processing device.

FIG. 17 is a block diagram illustrating a configuration example of hardware of a computer.

### MODE FOR CARRYING OUT THE INVENTION

Hereinafter, a mode for carrying out the present technology will be described. The description will be given in the following order.
1. Configuration of Acoustic System
2. Configuration of Signal Processing Device
3. Operation of Signal Processing Device
4. Modification

### <1. Configuration of Acoustic System>

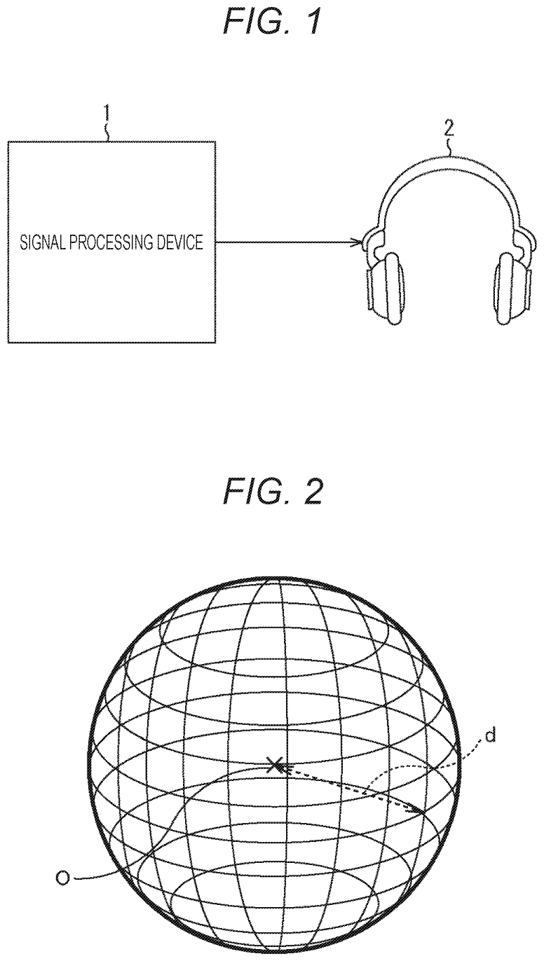

FIG. 1 is a block diagram illustrating a configuration example of an acoustic system according to an embodiment of the present technology.

The acoustic system of FIG. 1 is configured by connecting headphones 2 to a signal processing device 1. The signal processing device 1 and the headphones 2 may be connected by wired communication or wireless communication.

The signal processing device 1 includes a PC, a smartphone, a tablet terminal, an audio player, a game device, or the like. The signal processing device 1 performs reproduction from a sound source bit stream using an HRTF that is information of a frequency domain indicating a sound transfer characteristic from a virtual sound source to both ears of a user. The signal processing device 1 causes the headphones 2, which are an output device worn on the user's head, to output a sound corresponding to the sound source bit stream.

In the signal processing device 1, HRTFs for respective sound sources arranged on the full celestial sphere around a center position O of the user's head are prepared as illustrated in FIG. 2. In FIG. 2, a plurality of sound sources is arranged at positions away from the center position O by a distance d.

For one sound source, an HRTF for the left ear and an HRTF for the right ear are prepared. The HRTF for the left ear is represented by a ratio between a sound pressure level P_{L}(r, θ, φ, f, a) observed in the left ear and a sound pressure level P_{L}(r, f) observed at the center position O in the absence of the head, and is represented by the following formula (1).

$$\begin{matrix}[ Mathematical formula 1 ] & \\ {H}_{L} = {H}_{L} ( r , θ , ϕ , f , a ) = \frac{{P}_{L} ( r , θ , ϕ , f , a )}{{P}_{o} ( r , f )} & ( 1 )\end{matrix}$$

In Mathematical Formula (1), r represents a distance from the center position O to a sound source, and θ represents an azimuth angle with respect to the center position O. φ represents an elevation angle with respect to the center position O, and f represents a frequency. a represents a value for each user. Similarly, the HRTF for the right ear is represented by a ratio between the sound pressure level observed in the right ear and the sound pressure level observed at the center position O in the absence of the head.

Performing convolution processing on the sound source bit stream using an HRTF for a certain sound source enables the user to feel as if the user hears the sound corresponding to the sound source bit stream from the position of the sound source. Therefore, the acoustic system can stereoscopically reproduce a sound image of a sound corresponding to the sound source bit stream.

In general, it is known that HRTFs of sound sources having the same azimuth angle and elevation angle with respect to the center position O and at a distance of 1 m or more from the center position O are the same regardless of a distance from the center position O. Therefore, as an HRTF of a sound source at a distance of 1 m or more from the center position O, the signal processing device 1 uses an HRTF of a sound source having the azimuth angle and the elevation angle that are the same as the azimuth angle and the elevation angle of the sound source and at a distance of 1 m from the center position O. Hereinafter, the HRTF of the sound source at a distance of 1 m from the center position O is referred to as a far-field HRTF.

On the other hand, as an HRTF of a sound source at a distance of less than 1 m from the center position O, the signal processing device 1 needs to use an HRTF according to a distance from the center position O. Hereinafter, the HRTF of the sound source at a distance of less than 1 m from the center position O is referred to as a near-field HRTF. In order to reproduce a sound source virtually existing in a near-field, which is an area at a distance of less than 1 m from the center position O, with high accuracy, the near-field HRTF is required.

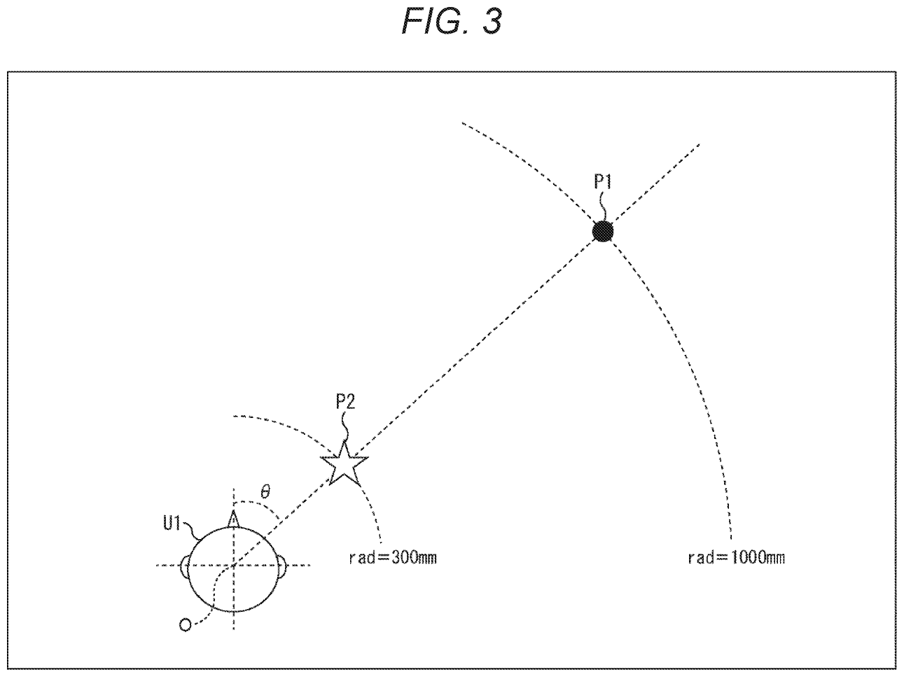

FIG. 3 is a diagram illustrating an example of a method of estimating the near-field HRTF.

As illustrated in FIG. 3, the signal processing device 1 generates a near-field HRTF for the sound source at a position P2 at a distance of 300 mm from the center position O on the basis of a far-field HRTF for the sound source at a position P1 at a distance of 1000 mm from the center position O. In FIG. 3, the position P1 and the position P2 are positions having the same azimuth angle and elevation angle such that the azimuth angle is θ deg and the elevation angle is θ deg with respect to the center position O.

Specifically, the signal processing device 1 generates the near-field HRTF at the position P2 by adjusting the far-field HRTF by changing interaural information indicated by the far-field HRTF for the sound source at the position P1 according to the head size of a user U1. The interaural information is information indicating a difference between both ears in how a sound output from a sound source is heard. For example, the signal processing device 1 adjusts the far-field HRTF by changing the ITD and the ILD as the interaural information.

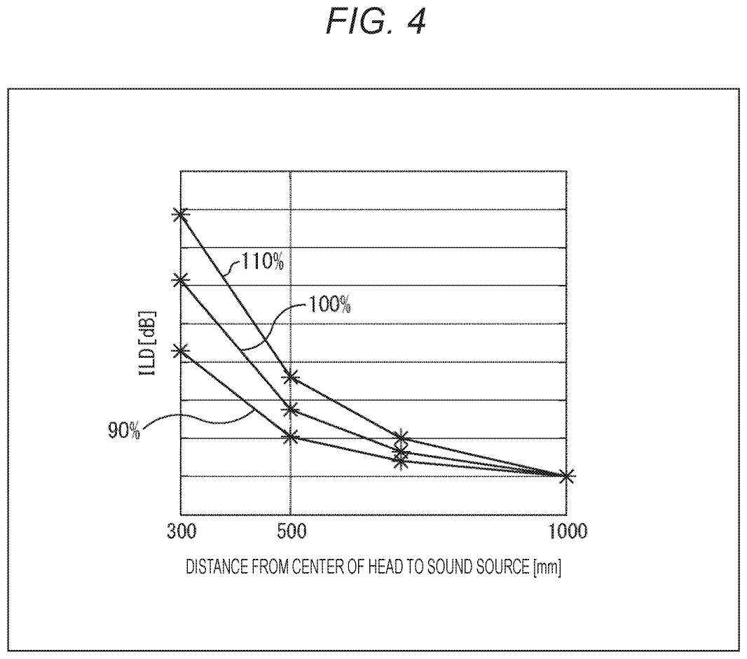

FIG. 4 is a diagram illustrating an example of the ILD according to a head size. FIG. 4 illustrates ILDs indicated by the HRTFs for sound sources having the same azimuth angle and elevation angle in a case where the head size is 90%, 100%, and 110%.

In FIG. 4, the horizontal axis represents a distance from the center position O to the sound sources, and the vertical axis represents an amount of change in the ILD where the ILD indicated by the far-field HRTF is set as a reference (0 dB).

As illustrated in FIG. 4, in a case where the head size is 110%, for example, the ILD indicated by the far-field HRTF is changed by +7 dB, so that the near-field HRTF of the sound source at a distance of 300 mm from the center position O is estimated.

On the other hand, in a case where the head size is 90%, for example, the ILD indicated by the far-field HRTF is changed by +3 dB, so that the near-field HRTF of the sound source at a distance of 300 mm from the center position O is estimated.

As described above, the amount by which the ILD indicated by the far-field HRTF should be changed for generation of the near-field HRTF depends on the size of the user's head. Similarly, the amount by which the ITD of the far-field HRTF should be changed for generation of the near-field HRTF also depends on the size of the user's head.

In the signal processing device 1, the far-field HRTF is adjusted by changing the ITD and the ILD according to a distance from the center position O to a sound source and the size of the user's head. As a result, the signal processing device 1 can estimate the near-field HRTF with higher accuracy than a case where the ITD and the ILD are changed only according to a distance from the center position to a sound source regardless of the size of the user's head.

Reproducing a sound source bit stream using the near-field HRTF optimized for the size of the user's head enables reproduction of the sound source virtually existing in the near-field with high accuracy.

### <2. Configuration of Signal Processing Device>

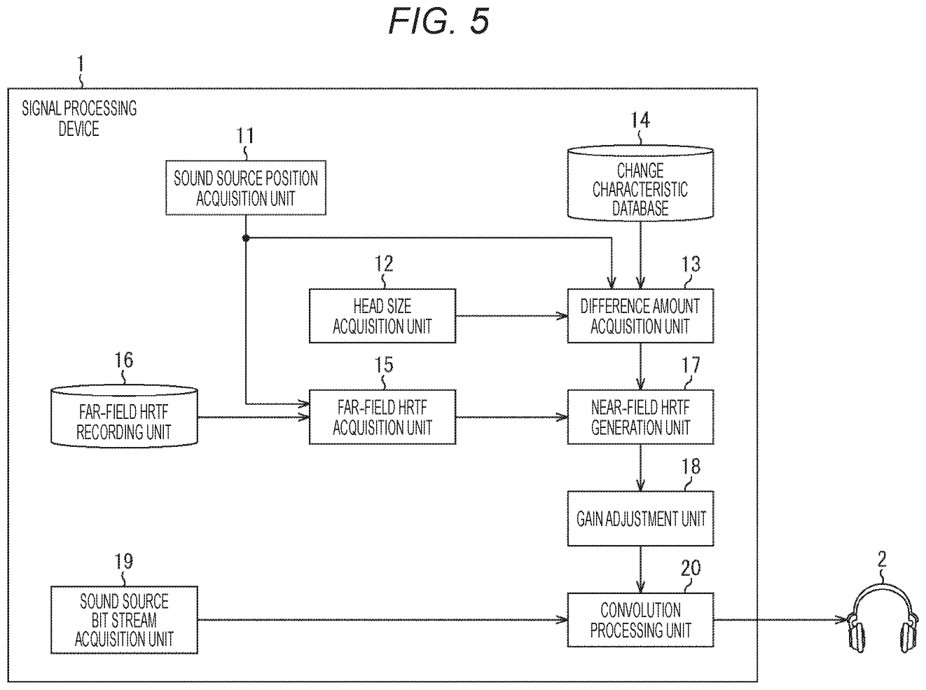

FIG. 5 is a block diagram illustrating a first configuration example of the signal processing device 1.

As illustrated in FIG. 5, the signal processing device 1 includes a sound source position acquisition unit 11, a head size acquisition unit 12, a difference amount acquisition unit 13, a change characteristic database 14, a far-field HRTF acquisition unit 15, a far-field HRTF recording unit 16, a near-field HRTF generation unit 17, a gain adjustment unit 18, a sound source bit stream acquisition unit 19, and a convolution processing unit 20.

The sound source position acquisition unit 11 acquires a sound source position of a sound source bit stream. For example, the sound source position acquisition unit 11 acquires the sound source position from the metadata of the sound source bit stream. The sound source position is indicated by, for example, an azimuth angle, an elevation angle, and a distance with respect to the center position of a user's head. Hereinafter, it is assumed that the sound source position of the sound source bit stream is a near-field sound source position at a distance of less than 1 m from the center position of the user's head. The sound source position acquisition unit 11 supplies information indicating the near-field sound source position to the difference amount acquisition unit 13 and the far-field HRTF acquisition unit 15.

The head size acquisition unit 12 acquires the size of the user's head. For example, the head size acquisition unit 12 acquires the size of the user's head that is, for example, measured in advance with a vernier caliper or the like, and that is input by the user via a user interface (UI). Note that, the size of the user's head may be registered in the signal processing device 1 in advance. The head size acquisition unit 12 supplies information indicating the size of the user's head to the difference amount acquisition unit 13.

With reference to the change characteristic database 14, the difference amount acquisition unit 13 acquires amounts of change in the ITD and the ILD according to the near-field sound source position acquired by the sound source position acquisition unit 11 and the size of the user's head acquired by the head size acquisition unit 12.

Specifically, the difference amount acquisition unit 13 acquires, as amounts of change in the ITD and the ILD, the difference amount between the ITD for the far-field sound source position and the ITD for the near-field sound source position, and the difference amount between the ILD for the far-field sound source position and the ILD for the near-field sound source position. The far-field sound source position has the same azimuth angle and elevation angle as the azimuth angle and elevation angle of the near-field sound source position, and is a position at a distance of 1 m from the center position of the head. The difference amount acquisition unit 13 supplies the difference amounts of the ITD and the ILD to the near-field HRTF generation unit 17.

In the change characteristic database 14, change characteristics of the ITD and the ILD for each sound source position are registered for each size of the user's head. For example, the change characteristics of the ITD and the ILD for each sound source position are calculated in advance on the basis of the HRTF acquired by numerical analysis, for example, using a rigid sphere model, or are calculated in advance by acoustic simulation or acoustic measurement.

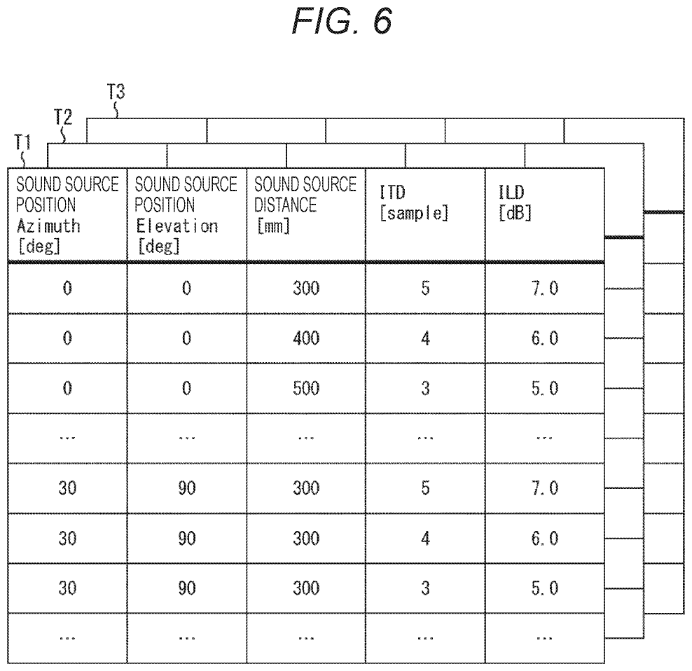

FIG. 6 is a diagram illustrating an example of information registered in the change characteristic database 14.

In the example of FIG. 6, tables T1 to T3 in which values of the ITD and the ILD are registered for an azimuth angle, an elevation angle, and a sound source distance indicating a sound source position are registered in the change characteristic database 14. The tables T1 to T3 correspond to the sizes of the user's head.

For example, in the table T1, it is registered that the ITD is 5 samples and the ILD is 7.0 dB for the sound source having the azimuth angle of 0 deg, the elevation angle of 0 deg, and the sound source distance of 300 mm. Note that, in FIG. 6, the unit of the ITD is sample, but the ITD may be expressed, for example, in a unit of msec or the like obtained by dividing sample by a sampling frequency. This similarly applies to the following.

In a case where the ITD and the ILD are frequency-independent values, the values of the ITD and the ILD for each sound source position are registered in the change characteristic database 14 for each head size as illustrated in FIG. 6.

On the other hand, in a case where the ITD and the ILD are frequency-dependent values, the values of the ITD and the ILD for each sound source position and each frequency are registered in the change characteristic database 14 for each head size. In this case, the ITD for each frequency acquired on the basis of a group delay characteristic, the ILD for each frequency acquired on the basis of an amplitude characteristic, the ITD and the ILD calculated from the data to which a bandpass filter has been applied, and the like are registered in the change characteristic database 14.

Note that, a value for calculating the ITD may be registered in the change characteristic database 14. For example, a start time of an impulse in a head-related impulse response (HRIR) which is time domain information indicating the sound transfer characteristic is registered in the change characteristic database 14 for each head size and frequency band.

A value for calculating the ILD may be registered in the change characteristic database 14.

For example, an average level of an amplitude characteristic in an HRTF is registered in the change characteristic database 14 for each head size and frequency band.

Returning to FIG. 5, the far-field HRTF acquisition unit 15 acquires, from the far-field HRTF recording unit 16, the HRTF (far-field HRTF) for the far-field sound source position corresponding to the near-field sound source position acquired by the sound source position acquisition unit 11. The far-field HRTF acquisition unit 15 supplies the far-field HRTF to the near-field HRTF generation unit 17.

In the far-field HRTF recording unit 16, for example, the far-field HRTF for each far-field sound source position is recorded. The far-field HRTF to be recorded in the far-field HRTF recording unit 16 is acquired by, for example, measurement using a microphone worn on both ears of the user, acoustic simulation, or estimation based on an image in which the ears of the user are in.

The near-field HRTF generation unit 17 generates the near-field HRTF by changing the ITD and the ILD indicated by the far-field HRTF supplied from the far-field HRTF acquisition unit 15 by the difference amounts acquired by the difference amount acquisition unit 13.

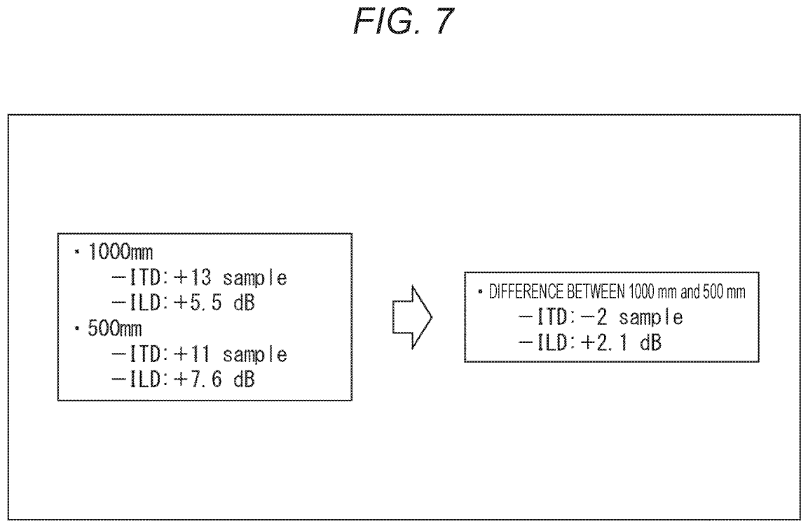

FIG. 7 is a diagram illustrating an example of amounts of change in the ITD and the ILD.

As illustrated on the left side of FIG. 7, for example, it is assumed that, as the ITD and the ILD for a sound source at a distance of 1000 mm from the center position of the head, a value of +13 samples and a value of +5.5 dB are registered in the change characteristic database 14, respectively. In addition, it is assumed that, as the ITD and the ILD for a sound source at a distance of 500 mm from the center position of the head, a value of +11 samples a value of +7.6 dB are registered in the change characteristic database 14, respectively.

In this case, as illustrated on the right side of FIG. 7, the difference amount acquisition unit 13 calculates a value of −2 samples as the difference amount of the ITD and calculates a value of +2.1 dB as the difference amount of the ILD. The near-field HRTF generation unit 17 changes the ITD indicated by the far-field HRTF by −2 samples and changes the ILD by +2.1 dB, thereby generating the near-field HRTF for the sound source at a distance of 500 mm from the center position of the head.

As described above, in the signal processing device 1, the near-field HRTF is generated by applying the difference amounts of the ITD and the ILD to the far-field HRTF. As a result, in a case where a far-field HRTF optimized for an individual is used to generate a near-field HRTF, the near-field HRTF can be generated while maintaining a feature such as the left-right asymmetry of the head of the individual. Note that, a near-field HRTF may be generated by rewriting the ITD and the ILD indicated by a far-field HRTF to the values registered in the change characteristic database 14.

The near-field HRTF generation unit 17 of FIG. 5 supplies the near-field HRTF to the gain adjustment unit 18.

The gain adjustment unit 18 performs, on the near-field HRTF, a gain adjustment according to the distance from the center position of the head to the near-field sound source position, and supplies the near-field HRTF to the convolution processing unit 20.

The sound source bit stream acquisition unit 19 acquires a sound source bit stream and supplies the sound source bit stream to the convolution processing unit 20. For example, the sound source bit stream acquisition unit 19 acquires the sound source bit stream from a medium connected to the signal processing device 1 or an external device connected via the Internet.

The convolution processing unit 20 performs convolution processing on the sound source bit stream supplied from the sound source bit stream acquisition unit 19 using the near-field HRTF on which gain processing according to the distance of the sound source has been performed by the gain adjustment unit 18. The convolution processing unit 20 supplies a binaural signal obtained by the convolution processing to the headphones 2 and causes the headphones 2 to outputs a sound corresponding to the binaural signal.

### <3. Operation of Signal Processing Device>

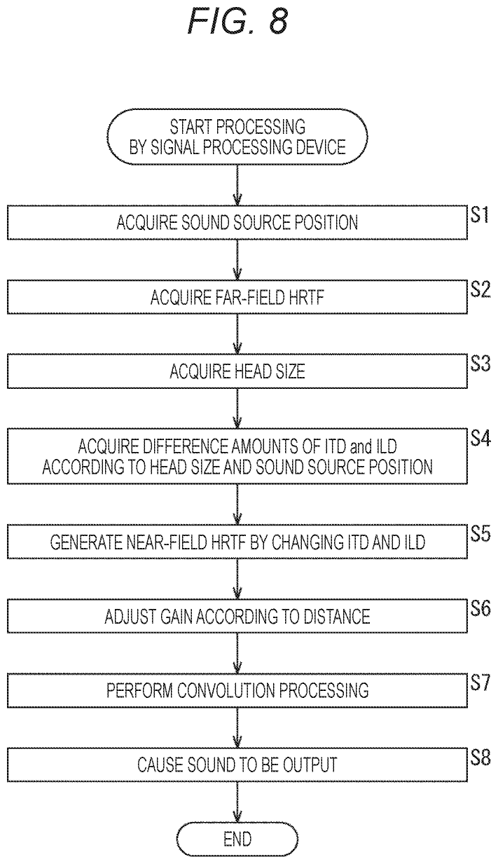

Here, with reference to the flowchart of FIG. 8, processing performed by the signal processing device having the above-described configuration will be described. The processing of FIG. 8 is started, for example, in a state where a sound source bit stream has been acquired by the sound source bit stream acquisition unit 19.

In step S1, the sound source position acquisition unit 11 acquires a near-field sound source position of the sound source bit stream.

In step S2, the far-field HRTF acquisition unit 15 acquires, from the far-field HRTF recording unit 16, a far-field HRTF for a far-field sound source position corresponding to the near-field sound source position.

In step S3, the head size acquisition unit 12 acquires the size of a user's head.

In step S4, with reference to the change characteristic database 14, the difference amount acquisition unit 13 acquires each of the difference amounts of the ITD and the ILD according to the size of the user's head and the near-field sound source position.

In step S5, the near-field HRTF generation unit 17 generates the near-field HRTF by changing the ITD and the ILD indicated by the far-field HRTF.

In step S6, the gain adjustment unit 18 adjusts a gain of the near-field HRTF according to the distance from the center position of the head to the near-field sound source position.

In step S7, the convolution processing unit 20 performs convolution processing on the sound source bit stream using the near-field HRTF to generate a binaural signal.

In step S8, the convolution processing unit 20 causes the headphones 2 to output a sound corresponding to the binaural signal.

As described above, in the signal processing device 1, the near-field HRTF is generated by changing the ITD and the ILD indicated by the far-field HRTF, according to the size of the user's head. This allows the signal processing device 1 to estimate the near-field HRTF with high accuracy. Performing the convolution processing using the highly-accurate near-field HRTF allows a sound source at a distance of less than 1 m from the center position of the user's head to be reproduced with high accuracy.

### <4. Modification>

### Example of Estimating Size of User's Head on the Basis of Far-field HRTF

In a case where the size of a user's head is unknown, the size of the user's head may be estimated on the basis of a far-field HRTF.

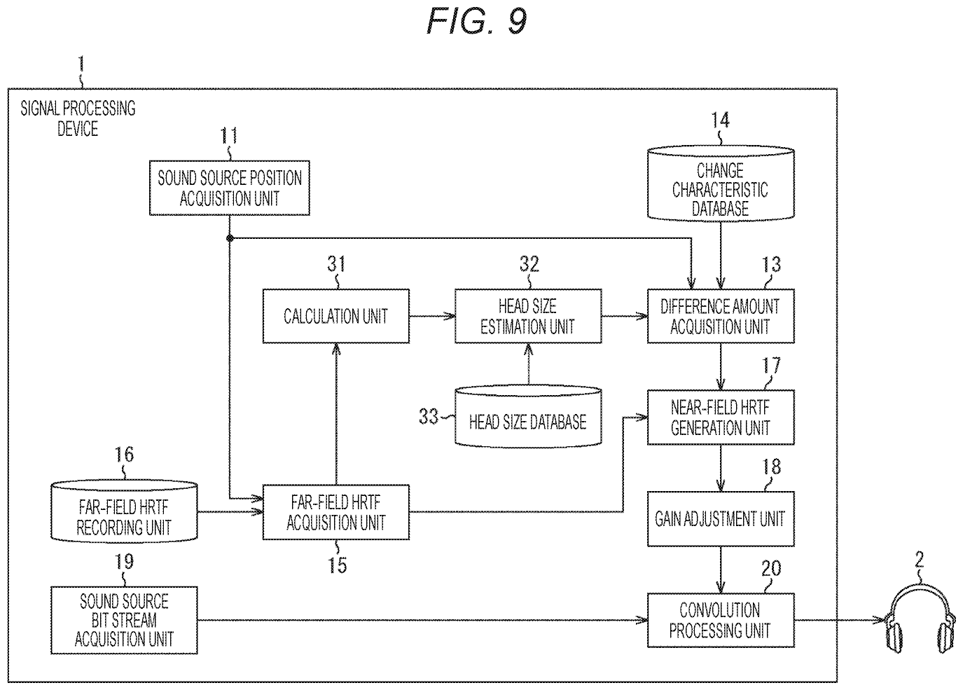

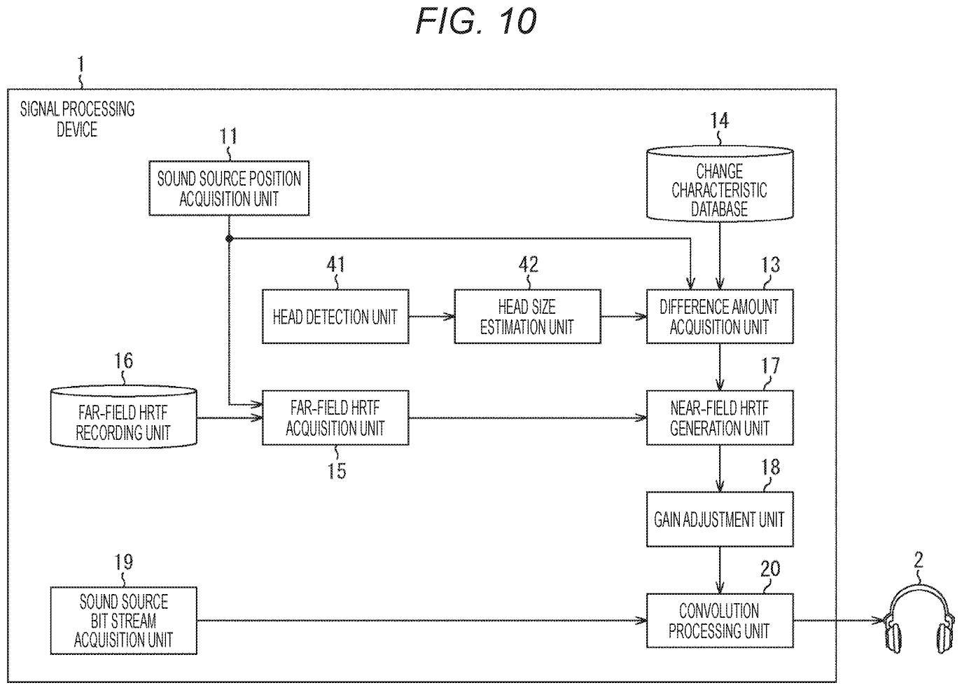

FIG. 9 is a block diagram illustrating a second configuration example of the signal processing device 1. In FIG. 9, the same components as the components described with reference to FIG. 5 are denoted by the same reference signs. Redundant description will be omitted as appropriate. The same applies to FIGS. 10, 11, 13, and 16 described later.

The configuration of the signal processing device 1 illustrated in FIG. 9 is different from the configuration of the signal processing device 1 of FIG. 5 in that a calculation unit 31, a head size estimation unit 32, and a head size database 33 are provided instead of the head size acquisition unit 12.

The far-field HRTF is supplied from the far-field HRTF acquisition unit 15 to the calculation unit 31. The calculation unit 31 calculates an ITD and an ILD indicated by the far-field HRTF, and supplies the ITD and the ILD to the head size estimation unit 32.

The head size estimation unit 32 acquires the size of the user's head by collating the ITD and the ILD calculated by the calculation unit 31 with an ITD and an ILD held for each head size in the head size database 33. The head size estimation unit 32 supplies information indicating the size of the user's head to the difference amount acquisition unit 13.

In the head size database 33, values of the ITD and the ILD for a far-field sound source position are registered for each head size.

With the configuration illustrated in FIG. 9, the signal processing device 1 can estimate the size of the user's head on the basis of the far-field HRTF.

### Example of Estimating Size of User's Head on the Basis of Image

In a case where the size of a user's head is unknown, the head size may be estimated on the basis of an image in which the user's head is.

FIG. 10 is a block diagram illustrating a third configuration example of the signal processing device 1.

The configuration of the signal processing device 1 illustrated in FIG. 10 is different from the configuration of the signal processing device 1 of FIG. 5 in that a head detection unit 41 and a head size estimation unit 42 are provided instead of the head size acquisition unit 12.

The head detection unit 41 acquires an image from a camera that has photographed the user's head. The head detection unit 41 detects the user's head from the image in which the user's head is, and supplies the detection result to the head size estimation unit 42.

The head size estimation unit 42 estimates the size of the user's head on the basis of the detection result of the user's head by the head detection unit 41, and supplies information indicating the size of the user's head to the difference amount acquisition unit 13.

With the configuration illustrated in FIG. 10, the signal processing device 1 can estimate the size of the user's head on the basis of the image in which the use's head is.

### Example in Which Sound Pressure Observed in Both Ears is Registered in Change Characteristic Database 14

A value based on the sound pressure level P_{L} observed in the left ear and a value based on the sound pressure level P_{R} observed in the right ear may be registered in the change characteristic database 14.

For example, the average level of the amplitude characteristic with respect to the frequency band, calculated on the basis of each of the sound pressure level P_{L} and the sound pressure level P_{R} is registered in the change characteristic database 14 for each size of the user's head. The average level of the amplitude characteristic includes information corresponding to the ILD and information corresponding to attenuation of the sound pressure according to a distance. Therefore, in this case, the gain adjustment according to the distance from the center position of a user's head to the near-field sound source position by the gain adjustment unit 18 is unnecessary.

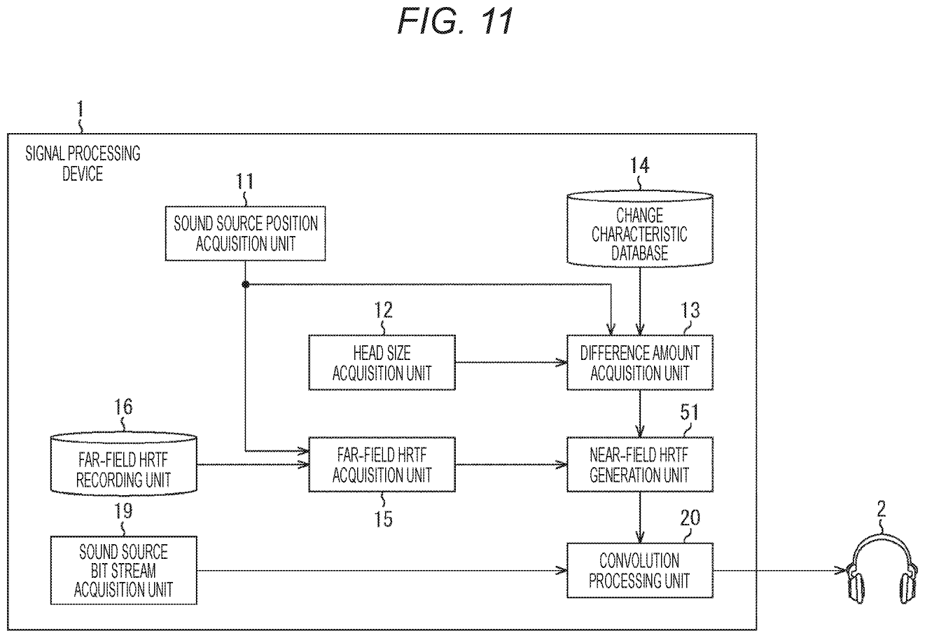

FIG. 11 is a block diagram illustrating a fourth configuration example of the signal processing device 1.

The configuration of the signal processing device 1 illustrated in FIG. 11 is different from the configuration of the signal processing device 1 of FIG. 5 in that the gain adjustment unit 18 is not provided and a near-field HRTF generation unit 51 is provided instead of the near-field HRTF generation unit 17.

As described above, the average value of the amplitude characteristic based on each of the sound pressure level P_{L} and the sound pressure level P_{R} is registered in the change characteristic database 14 for each size of the user's head.

With reference to the change characteristic database 14, the difference amount acquisition unit 13 acquires amounts of change in the ITD and the average level of the amplitude characteristic, according to the near-field sound source position and the size of the user's head.

Specifically, the difference amount acquisition unit 13 acquires the difference amount between the ITD for the far-field sound source position and the ITD for the near-field sound source position, and the difference amount between the average level of the amplitude characteristic for the far-field sound source position and the average level of the amplitude characteristic for the near-field sound source position as amounts of change in the ITD and the average level of the amplitude characteristic. The difference amount acquisition unit 13 supplies the difference amounts of the ITD and the average level of the frequency characteristic to the near-field HRTF generation unit 17.

The near-field HRTF generation unit 51 generates a transfer characteristic by changing the ITD indicated by the far-field HRTF and the gain of the far-field HRTF by the difference amount acquired by the difference amount acquisition unit 13. This transfer characteristic is a characteristic obtained by performing, on the near-field HRTF, gain processing according to the distance from the center position of the head to the near-field sound source position. The near-field HRTF generation unit 51 supplies the transfer characteristic to the convolution processing unit 20.

The convolution processing unit 20 performs convolution processing on the sound source bit stream using the transfer characteristic generated by the near-field HRTF generation unit 51.

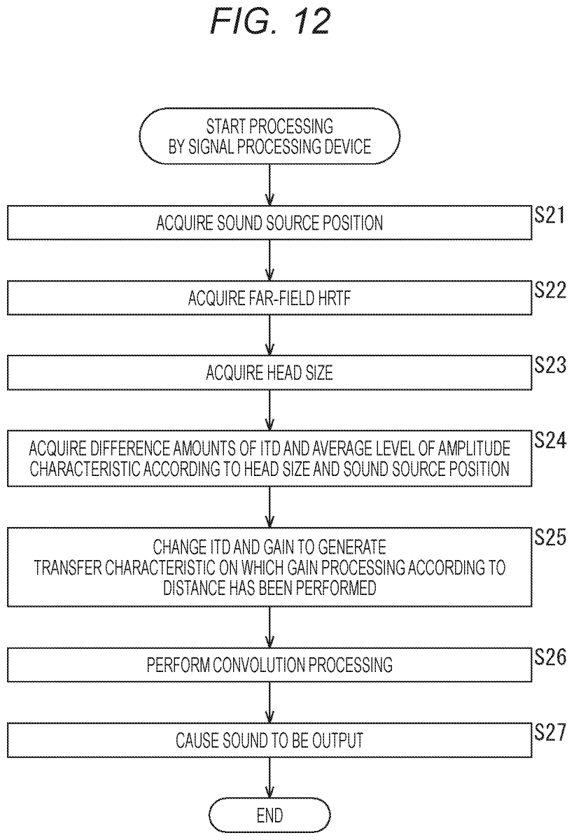

With reference to the flowchart of FIG. 12, the processing performed by the signal processing device 1 having the configuration of FIG. 11 will be described.

The processing in steps S21 to S23 is similar to the processing in steps S1 to S3 of FIG. 8. Through the above processing, the near-field sound source position, the far-field HRTF, and the size of the user's head are acquired.

In step S24, with reference to the change characteristic database 14, the difference amount acquisition unit 13 acquires the respective difference amounts of the ITD and the average level of the amplitude characteristic according to the size of the user's head and the near-field sound source position.

In step S25, the near-field HRTF generation unit 51 changes the ITD and the gain indicated by the far-field HRTF to generate the transfer characteristic on which the gain processing according to the distance from the center position of the head to the near-field sound source position has been performed.

In step S26, the convolution processing unit 20 performs convolution processing on the sound source bit stream using the transfer characteristic generated in step S25 to generate a binaural signal.

In step S27, the convolution processing unit 20 causes the headphones 2 to output a sound corresponding to the binaural signal.

As described above, the signal processing device 1 can reproduce a sound without adjusting the gain according to the distance from the center position of the head to the near-field sound source position.

### Example of Interpolating Far-field HRTF

In a case where the far-field HRTF for a desired far-field sound source position is not recorded in the far-field HRTF recording unit 16, the far-field HRTF for the far-field sound source position may be interpolated on the basis of the far-field HRTF for a position near the far-field sound source position.

### Example of Interpolating Change Characteristics of ITD and ILD

In a case where the change characteristics of the ITD and the ILD for a desired near-field sound source position or a desired long-field sound source position are not registered in the change characteristic database 14, the change characteristics of the ITD and the ILD for the desired sound source position may be interpolated on the basis of the change characteristics of the ITD and the ILD for a position near the desired sound source position.

### Example in Which User Adjusts Amounts of Change in ITD and ILD

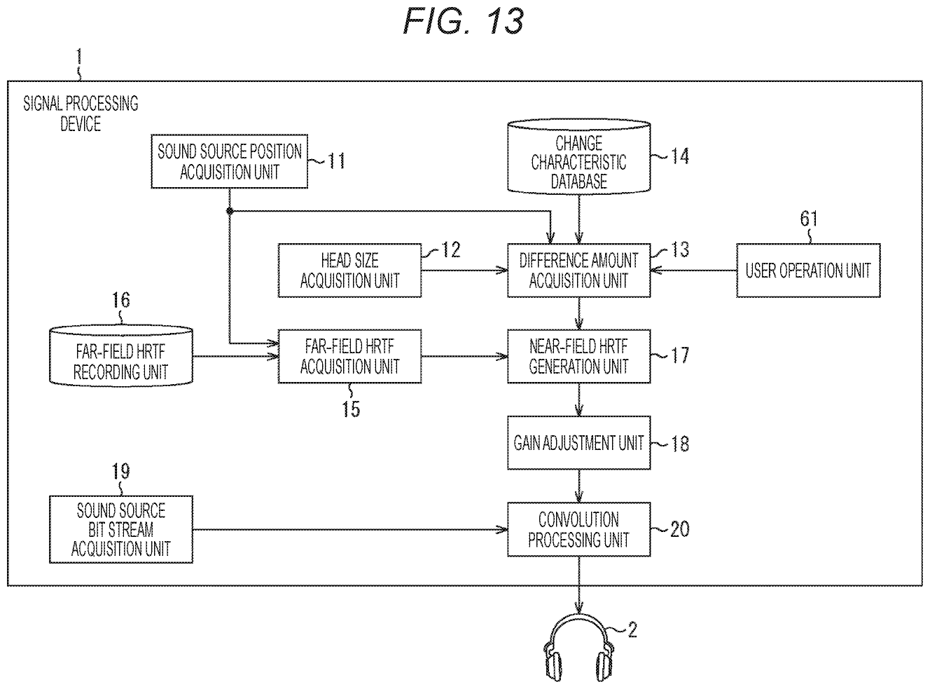

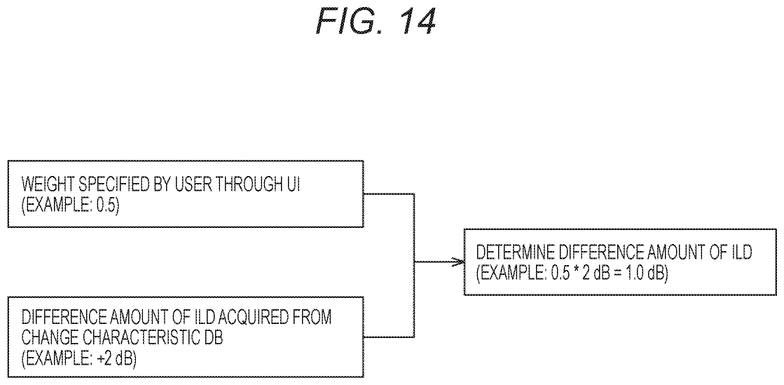

FIG. 13 is a block diagram illustrating a fifth configuration example of the signal processing device 1.

The configuration of the signal processing device 1 illustrated in FIG. 13 is different from the configuration of the signal processing device 1 of FIG. 5 in that a user operation unit 61 is provided.

The user operation unit 61 is a UI for receiving an input of an operation for specifying a weight to be applied to difference amounts of the ITD and the ILD.

The difference amount acquisition unit 13 sets difference amounts to which the weight specified by a user through the user operation unit 61 is applied, as the difference amounts of the ITD and the ILD.

FIG. 14 is a diagram illustrating a flow of adjustment of the difference amounts of the ITD and the ILD.

As illustrated on the left side of FIG. 14, it is assumed that a user specifies a value of 0.5 as the weight using the UI. In addition, it is assumed that the difference amount acquisition unit 13 acquires a value of +2 dB as a difference amount of the ILD with reference to the change characteristic database 14.

In this case, as illustrated on the right side of FIG. 14, the difference amount acquisition unit 13 determines a value of 0.5*2 dB=1.0 dB, which is a product of the difference amount of the ILD and the weight, as the final difference amount of the ILD.

In this manner, for example, the user can adjust the change amounts of the ITD and the ILD to optimum amounts by specifying the weight while listening to a sound output from the headphones 2.

### Example of Centering on Position of Entrance of User's Ear Canal

The example in which the far-field sound source position is determined on the basis of an azimuth angle and an elevation angle in the coordinate system with respect to the center position of a user's head as the position of the user has been described above. The far-field sound source position may be determined on the basis of an azimuth angle and an elevation angle in a coordinate system with respect to the position of the entrance of the ear canal as the position of the user.

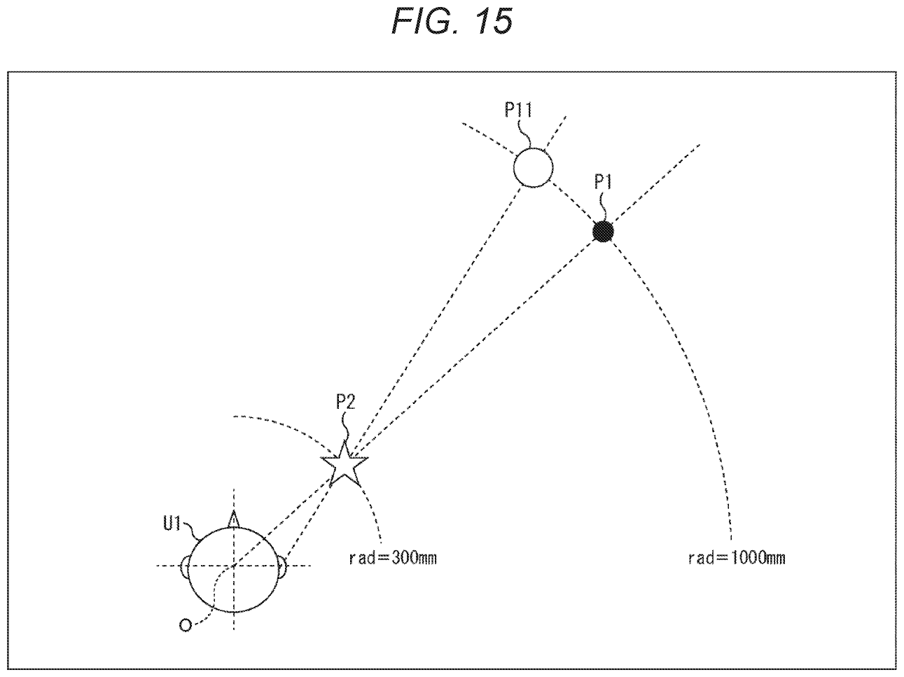

FIG. 15 is a diagram illustrating an example of the far-field sound source position to be determined on the basis of an azimuth angle and an elevation angle in the coordinate system with respect to the position of the entrance of the ear canal.

As illustrated in FIG. 15, the signal processing device 1 generates the near-field HRTF for the right ear for the sound source at the position P2 not on the basis of the far-field HRTF of the sound source at the position P1 but on the basis of the far-field HRTF of the sound source at a position P11, for example. The position P11 is a position having the same azimuth angle and the elevation angle as the azimuth angle and the elevation angle of the position P2 with respect to the position of the entrance of the ear canal of the right ear of the user, and is a position at 1000 mm from the center position O.

In general, the spectrum of a sound observed in both ears of the user depends on the angle of incidence to the entrance of the ear canal. Therefore, the difference in the shape of the spectrum between the far-field HRTF and the near-field HRTF is smaller using the coordinate system with respect to the entrance of the ear canal than using the coordinate system with respect to the center of the head.

### Example of Correcting Frequency Characteristics According to Head Size

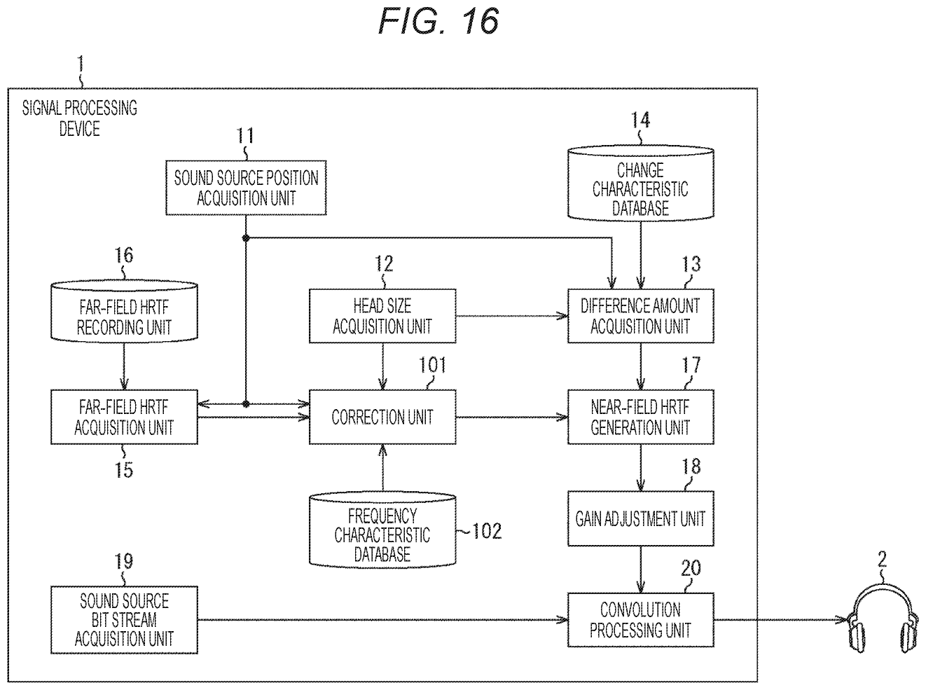

FIG. 16 is a block diagram illustrating a sixth configuration example of the signal processing device 1.

The configuration of the signal processing device 1 illustrated in FIG. 16 is different from the configuration of the signal processing device 1 of FIG. 5 in that a correction unit 101 and a frequency characteristic database 102 are provided.

To the correction unit 101, the information indicating the near-field sound source position is supplied from the sound source position acquisition unit 11 and the information indicating the size of a user's head is supplied from the head size acquisition unit 12. In addition, to the correction unit 101, the far-field HRTF is supplied from the far-field HRTF acquisition unit 15.

The correction unit 101 corrects the frequency characteristic of the far-field HRTF so as to reproduce the influence of the user's head. This correction is performed on the basis of the information indicating an amount of change in the frequency characteristic of the near-field HRTF according to the size of the user's head acquired from the frequency characteristic database 102. The correction unit 101 supplies the corrected HRTF to the near-field HRTF generation unit 17.

In the frequency characteristic database 102, for example, an amount of change in the frequency characteristic of an HRTF for each sound source position due to the influence of the user's head is registered for each size of the user's head.

The near-field HRTF generation unit 17 generates the near-field HRTF by changing the ITD and the ILD indicated by the HRTF supplied from the correction unit 101 by the difference amount acquired by the difference amount acquisition unit 13.

As described above, when the frequency characteristic of the HRTF is corrected so as to reproduce the influence of the user's head, a correction amount for each frequency band can be changed according to the head size. Note that, the correction according to the head size performed by the correction unit 101 may be performed on the near-field HRTF generated by the near-field HRTF generation unit 17.

### Method for Acquiring Head Size

For example, the head size acquisition unit 12 acquires the size of a user's head on the basis of the detection result of a distance sensor that detects a distance to the user's head.

For example, the head size acquisition unit 12 acquires, as a head size, the distance between the device on the left channel (Lch) side and the device on the right channel (Rch) side based on the detection result of the sensors provided individually in the device on the Lch side and the device on the Rch side of the headphones 2. For example, the head size acquisition unit 12 acquires the size of the user's head on the basis of an adjustment amount of the length of a headband provided in the headphones 2.

For example, in a case where the user wears a glasses-type device on his/her head, the head size acquisition unit 12 acquires the size of the user's head on the basis of a distance between sensors installed in temples, moderns, or the like of the glasses-type device.

For example, in a case where the user wears a device such as a head mounted display, augmented reality (AR) glasses, or virtual reality (VR) glasses on his/her head, the head size acquisition unit 12 acquires the size of the user's head on the basis of an adjustment amount of the length of the headband provided in such a device.

### Others

Although the example in which the near-field HRTF is generated by changing the ITD and the ILD indicated by the far-field HRTF has been described above, the HRTF for the sound source farther from the position of a user than the sound source corresponding to the near-field HRTF may be generated by changing the ITD and the ILD indicated by the near-field HRTF.

The near-field HRTF may be generated by changing the ITD and the ILD indicated by the far-field HRTF by a difference amount according to the shape of the user's head as well as the size of the user's head.

The sound corresponding to a binaural signal may be output by another output device other than the headphones 2.

### Application Example

The present technology can be applied to, for example, expressing a sound virtually generated at a close distance from a user. For example, a sound in a situation where a character is talking to a user from above his/her shoulder can be expressed with high accuracy, or a sound in a situation where an insect flies around a user can be expressed with high accuracy. In addition, a sound of whispering voice and a sound of scissors during hair cutting can be expressed with high accuracy.

The present technology can also be applied to expressing a moving sound, for example. For example, a sound emitted by an object approaching a user or a sound emitted by a moving object can be expressed with high accuracy.

### Computer

The processing performed by the signal processing device 1 described above can be performed by hardware or software. In a case where a series of processing steps is performed by software, the program constituting the software is installed from a program recording medium on a computer incorporated in dedicated hardware, a general-purpose personal computer, or the like.

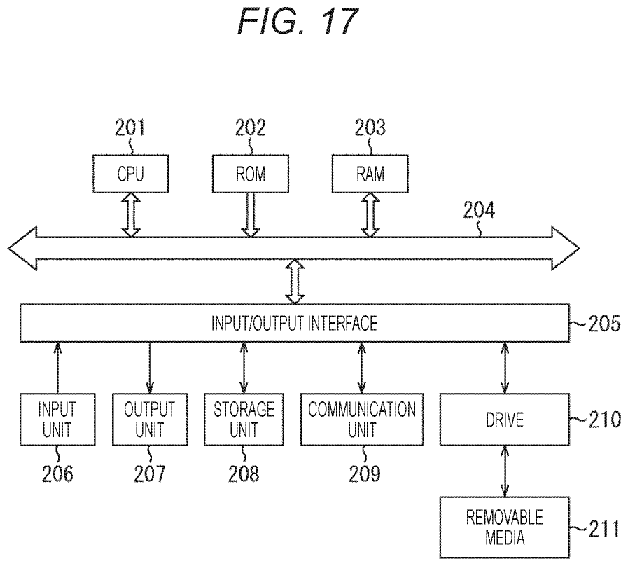

FIG. 17 is a block diagram illustrating a configuration example of hardware of a computer that executes the series of processing described above by a program.

A central processing unit (CPU) 201, a read only memory (ROM) 202, and a random access memory (RAM) 203 are mutually connected by a bus 204.

An input/output interface 205 is further connected to the bus 204. An input unit 206 including a keyboard, a mouse, and the like, and an output unit 207 including a display, a speaker, and the like are connected to the input/output interface 205. In addition, a storage unit 208 including a hard disk, a non-volatile memory, or the like, a communication unit 209 including a network interface or the like, and a drive 210 that drives a removable medium 211 are connected to the input/output interface 205.

In the computer configured as described above, for example, the CPU 201 loads the program stored in the storage unit 208 into the RAM 203 via the input/output interface 205 and the bus 204 and executes the program, and thus the series of processing described above is performed.

The program executed by the CPU 201 is provided, for example, by being recorded in the removable medium 211 or via a wired or wireless transmission medium such as a local area network, the Internet, or digital broadcasting, and is installed on the storage unit 208.

Note that, the program executed by the computer may be a program that is processed in time series in the order described in the present specification, or a program that is processed in parallel or at a necessary timing such as when a call is made.

Note that, in the present specification, a system means a set of a plurality of components (devices, modules (parts), and the like), and it does not matter whether or not all the components are in the same housing. Therefore, a plurality of devices housed in separate housings and connected to each other via a network and one device in which a plurality of modules is housed in one housing are both systems.

Note that, the effects described in the present specification are merely examples and are not limited, and there may be other effects.

An embodiment of the present technology is not limited to the above-described embodiment, and various modifications can be made without departing from the scope of the present technology.

For example, the present technology may be configured as cloud computing in which a function is shared by a plurality of devices via a network to process together.

In addition, each step described in the above flowcharts can be executed by one device or shared and performed by a plurality of devices.

Moreover, in a case where a plurality of processing steps is included in one step, the plurality of processing included in the one step can be performed by one device or shared and performed by a plurality of devices.

### Combination Example of Configurations

The present technology may also have the following configuration.

(1)

A signal processing device including:
a generation unit that generates a second HRTF from a second sound source position to a position of a user by changing interaural information indicated by a first HRTF from a first sound source position to the position of the user according to a shape of the user's head, the second sound source position being at the same angle as the first sound source position with reference to the position of the user.
   (2)

The signal processing device according to (1), in which
the generation unit acquires a difference amount between the interaural information for the second sound source position and the interaural information for the first sound source position by referring to a database in which a change characteristic of the interaural information for a sound source position is registered for each shape of the user's head, and changes the interaural information indicated by the first HRTF by the difference amount.
   (3)

The signal processing device according to (1) or (2), in which
the interaural information is at least one of an ITD and an ILD.
   (4)

The signal processing device according to any one of (1) to (3), in which
the first sound source position is a position farther from the position of the user than the second sound source position.
   (5)

The signal processing device according to any one of (1) to (3), in which
the first sound source position is a position closer to the position of the user than the second sound source position.
   (6)

The signal processing device according to any one of (1) to (5), in which
in the database, the interaural information for the sound source position and a frequency is registered for each shape of the user's head.
   (7)

The signal processing device according to (2), in which
in the database, information for calculating the interaural information for the sound source position is registered for each shape of the user's head.
   (8)

The signal processing device according to (2), in which
in the database, information based on a sound pressure level of a sound reaching both ears of the user from the sound source position is registered for each shape of the user's head.
   (9)

The signal processing device according to any one of (1) to (8), further including:
an acquisition unit that acquires a shape of the user's head.
   (10)

The signal processing device according to (9), in which
the acquisition unit acquires the shape of the user's head by collating the interaural information indicated by the first HRTF with the interaural information held for each shape of the user's head.
   (11)

The signal processing device according to (9), in which
the acquisition unit acquires the shape of the user's head input by the user.
   (12)

The signal processing device according to (9), in which
the acquisition unit acquires the shape of the user's head on the basis of an image in which the user's head is, a detection result by a distance sensor that detects a distance to the user's head, or a detection result by a sensor provided in a device worn by the user.
   (13)

The signal processing device according to any one of (1) to (12), in which
the generation unit generates the second HRTF by interpolating the first HRTF on the basis of a third HRTF from a third sound source position near the first sound source position to the position of the user.
   (14)

The signal processing device according to (2), in which
the generation unit acquires the difference amount by interpolating the interaural information for the first sound source position on the basis of the interaural information for a fourth sound source position near the first sound source position registered in the database, or by interpolating the interaural information for the second sound source position on the basis of the interaural information for a fifth sound source position near the second sound source position registered in the database.
   (15)

The signal processing device according to (2), in which
the generation unit changes the interaural information indicated by the first HRTF by the difference amount to which a weight specified by the user is applied.
   (16)

The signal processing device according to any one of (1) to (15), in which
the position of the user is a position of a center of the user's head or a position of an ear canal entrance of the user.
   (17)

The signal processing device according to any one of (1) to (16), further including:
a correction unit that corrects a frequency characteristic of a first HRTF or a second HRTF according to the shape of the user's head.
   (18)

A signal processing method, including:
generating a second HRTF from a second sound source position to a position of a user by changing interaural information indicated by a first HRTF from a first sound source position to the position of the user according to a shape of the user's head, the second sound source position being at the same angle as the first sound source position with reference to the position of the user.
   (19)

A program for causing a computer to execute processing of:
generating a second HRTF from a second sound source position to a position of a user by changing interaural information indicated by a first HRTF from a first sound source position to the position of the user according to a shape of the user's head, the second sound source position being at the same angle as the first sound source position with reference to the position of the user.

### REFERENCE SIGNS LIST

1 Signal processing device
2 Headphones
11 Sound source position acquisition unit
12 Head size acquisition unit
13 Difference amount acquisition unit
14 Change characteristic database
15 Far-field HRTF acquisition unit
16 Far-field HRTF recording unit
17 Near-field HRTF generation unit
18 Gain adjustment unit
19 Sound source bit stream acquisition unit
20 Convolution processing unit
31 Calculation unit
32 Head size estimation unit
33 Head size database
41 Head detection unit
42 Head size estimation unit
51 Near-field HRTF generation unit
61 User operation unit
101 Correction unit
102 Frequency characteristic database

1. A signal processing device comprising:
a generation unit that generates a second HRTF from a second sound source position to a position of a user by changing interaural information indicated by a first HRTF from a first sound source position to the position of the user according to a shape of the user's head, the second sound source position being at a same angle as the first sound source position with reference to the position of the user.

2. The signal processing device according to claim 1, wherein
the generation unit acquires a difference amount between the interaural information for the second sound source position and the interaural information for the first sound source position by referring to a database in which a change characteristic of the interaural information for a sound source position is registered for each shape of the user's head, and changes the interaural information indicated by the first HRTF by the difference amount.

3. The signal processing device according to claim 1, wherein
the interaural information is at least one of an ITD and an ILD.

4. The signal processing device according to claim 1, wherein
the first sound source position is a position farther from the position of the user than the second sound source position.

5. The signal processing device according to claim 1, wherein
the first sound source position is a position closer to the position of the user than the second sound source position.

6. The signal processing device according to claim 2, wherein
in the database, the interaural information for the sound source position and a frequency is registered for each shape of the user's head.

7. The signal processing device according to claim 2, wherein
in the database, information for calculating the interaural information for the sound source position is registered for each shape of the user's head.

8. The signal processing device according to claim 2, wherein
in the database, information based on a sound pressure level of a sound reaching both ears of the user from the sound source position is registered for each shape of the user's head.

9. The signal processing device according to claim 1, further comprising:
an acquisition unit that acquires a shape of the user's head.

10. The signal processing device according to claim 9, wherein
the acquisition unit acquires the shape of the user's head by collating the interaural information indicated by the first HRTF with the interaural information held for each shape of the user's head.

11. The signal processing device according to claim 9, wherein
the acquisition unit acquires the shape of the user's head input by the user.

12. The signal processing device according to claim 9, wherein
the acquisition unit acquires the shape of the user's head on a basis of an image in which the user's head is, a detection result by a distance sensor that detects a distance to the user's head, or a detection result by a sensor provided in a device worn by the user.

13. The signal processing device according to claim 1, wherein
the generation unit generates the second HRTF by interpolating the first HRTF on a basis of a third HRTF from a third sound source position near the first sound source position to the position of the user.

14. The signal processing device according to claim 2, wherein
the generation unit acquires the difference amount by interpolating the interaural information for the first sound source position on a basis of the interaural information for a fourth sound source position near the first sound source position registered in the database, or by interpolating the interaural information for the second sound source position on a basis of the interaural information for a fifth sound source position near the second sound source position registered in the database.

15. The signal processing device according to claim 2, wherein
the generation unit changes the interaural information indicated by the first HRTF by the difference amount to which a weight specified by the user is applied.

16. The signal processing device according to claim 1, wherein
the position of the user is a position of a center of the user's head or a position of an ear canal entrance of the user.

17. The signal processing device according to claim 1, further comprising:
a correction unit that corrects a frequency characteristic of a first HRTF or a second HRTF according to the shape of the user's head.

18. A signal processing method comprising:
generating a second HRTF from a second sound source position to a position of a user by changing interaural information indicated by a first HRTF from a first sound source position to the position of the user according to a shape of the user's head, the second sound source position being at a same angle as the first sound source position with reference to the position of the user.

19. A program for causing a computer to execute processing of:
generating a second HRTF from a second sound source position to a position of a user by changing interaural information indicated by a first HRTF from a first sound source position to the position of the user according to a shape of the user's head, the second sound source position being at a same angle as the first sound source position with reference to the position of the user.
